(19) United States
(12) Patent Application Publication
(10) Pub. No.: US 2004/0083125 A1
(43) Pub. Date: Apr. 29, 2004

(54) Method and system for delivering customer services to independent insurance agents

(76) Inventors: John M. Almeida, Rowley, MA (US); Daniel D. Loranger, N. Andover, MA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/690,725

(22) Filed: Oct. 22, 2003

Related U.S. Application Data
(63) Continuation of application No. 09/496,703, filed on Feb. 2, 2000.
(60) Provisional application No. 60/122,404, filed on Mar. 2, 1999.

(51) Int. Cl. G06F 17/60

(52) U.S. Cl. 705/4

(57) ABSTRACT

The present invention relates to a method and system for coordinating customer services provided by a plurality of independent insurance agents by an insurance carrier. The present invention describes a method and system provided by an insurance carrier for creating an agents virtual electronic community. The agents virtual electronic community includes an environment that facilitates doing business between an insurance carrier, an insurance agent, a vendor, and a consumer in a more efficient manner. The method of the invention simultaneously places the various parties in one virtual location where automobile insurance related services can be obtained.

### RELATED APPLICATION

This application is a continuation application of application Ser. No. 09/496,703, filed Feb. 2, 2000, which is a Non-Provisional Application claiming priority from U.S. Provisional Application No. 60/122,404, filed Mar. 2, 1999.

### FIELD OF THE INVENTION

The present invention relates to a method and system for coordinating customer services provided by a plurality of independent insurance agents through an insurance carrier, and more particularly to coordinating automobile insurance related services provided by the plurality of independent insurance agents through the insurance carrier.

### BACKGROUND OF THE INVENTION

The automobile insurance services industry generally comprises an insurance carrier, an insurance agent, and vendors that provide services to a consumer. The insurance carriers, insurance agents, and vendors typically render automobile insurance related services to the consumer through face-to-face or telephonic contact. In most cases, the insurance agent is typically the central point of contact through which services are obtained.

There are ordinarily two types of agents that provide automobile insurance related services, authorized agents and independent agents. Authorized insurance agents primarily provide insurance policies from a single insurance carrier, and independent insurance agents provide insurance policies from different insurance carriers. The independent agent is usually more able to provide an insurance policy that meets a particular consumer's needs since they typically have different types of policies from which to select. The independent agent is unlike the authorized agent who is generally only able to provide one type of policy offered by a specific insurance carrier.

The agents ordinarily earn a commission based upon the value of the insurance policy, and the insurance carrier collects income whenever the consumer pays the premium associated with that policy. The insurance carrier generates revenue whenever an agent, independent or authorized, provides one of their insurance policies to a consumer seeking insurance protection.

The vendors often include automobile repair shops, window and windshield replacement centers, rental car providers, and providers of replacement automotive parts whenever the consumer requires a service covered (either partially or wholly) by their automobile insurance policy. Depending upon the consumer's deductible limitations in their automobile insurance policy, the insurance carrier pays the vendor for services rendered, and the consumer may pay a small portion of that expense.

The business transactions that occur between vendors, insurance agents, insurance carriers, and the customer take place in discrete disconnected environments. That is, the insurance carriers typically communicate with the agents and possibly the vendors, and the agents generally communicate with the vendors on behalf of the consumers. The consumers primarily communicate with the agents and the vendors. However, neither group is rarely, if ever, co-located and able to simultaneously communicate with each other. As a result, the needs of the consumer may not always be clearly communicated, and may require the consumer to physically visit or make telephone calls to several places before obtaining the requisite service. The agent may also be required to physically visit or make telephone calls to several places before obtaining a desired service for the consumer.

Historically, in the automobile insurance industry, providing a centralized communications environment between the various parties has been cost prohibitive. In addition, the magnitude of the costs and the required resources could only logically be sustained by the insurance carrier. The prohibitions to providing centralized communications were primarily a function of the scattered locations of the various independent agents, and the manner in which the insurance industry has typically conducted business. Specifically, the industry operates by face to face communications between the agents, vendors and consumers. In addition, the insurance carrier has also lacked incentive to provide centralized communications between the independent agents and the vendors.

As stated above, the insurance policies maintained by an insurance carrier are often sold by independent insurance agents who provide several types of insurance policies from different insurance carriers. As a result, an insurance carrier is not guaranteed that a particular agent, not under exclusive contract, will sell the insurance carrier's particular type of insurance. Accordingly, the insurance carrier has had no incentive to bear the cost of implementing a centralized communications environment that connects the independent insurance agent to a group of vendors.

In addition, the independent agent is typically unable to have access to more than a few vendors at any given time. As a result, the independent agent may not have any method of obtaining the best pricing schemes for a consumer.

The consumer, likely entering an unfamiliar vendor's market, is probably unaware of the vendors themselves, the services provided, the quality of services, and vendor pricing schemes.

The present invention described herein resolves the communication difficulties between the various parties who provide automobile insurance related services to a consumer.

### SUMMARY OF THE INVENTION

The present invention describes a method and system provided by an insurance carrier for creating an Agents Virtual Community™. The Agents Virtual Community includes an environment that facilitates doing business between an insurance carrier, an insurance agent, a vendor, and a consumer in a more efficient manner. The method of the invention simultaneously places the various parties in one virtual location where automobile insurance related services can be obtained.

By utilizing a method of the invention, the insurance carrier, the independent agent, the vendors, and the consumer each receive a benefit. In particular, when the agent provides more efficient services the consumer is satisfied. Consumer satisfaction generally corresponds to additional business for the agent that potentially translates into an increased number of insurance policies issued to consumers. The increased number of policies may correspond to more premiums being collected, thereby increasing revenues for the insurance carrier, the agent, and the vendors while the consumer receives higher quality services at potentially lower costs.

In general, embodiments of the present invention feature a method for coordinating customer services provided by a plurality of independent insurance agents through a provider, the method includes the steps of coupling each of the plurality of independent insurance agents to an electronic common area through a computing network via a high-speed electronic connection; coupling a plurality of vendors to the electronic common area through a global communications network; and enabling each of the independent insurance agents to contact each of the plurality of vendors through the computing network.

One aspect of the invention features the step of providing insurance related software applications to each of the plurality of independent insurance agents over the computing network.

Another aspect of the invention features the step of using digital certificates to provide security over the computing network.

In another aspect of the invention, the step of coupling each of the plurality of independent insurance agents to the electronic common area through the computing network via the high-speed electronic connection includes coupling through a dedicated communication system using frame routers.

In yet another aspect, the present invention features coupling each of the plurality of independent insurance agents to a computing system that includes the step of coupling the agents through a global communications network connection.

Another aspect of the invention features a method of providing access to insurance related services to a plurality of independent insurance agents. The method includes the steps of providing a communications network that connects the plurality of independent insurance agents to a plurality of vendors; providing as part of the communications network an electronic common area between the plurality of independent insurance agents and the plurality of vendors; and allowing the plurality of independent insurance agents to select a plurality of vendors from the electronic common area. The electronic common area, referred to as the Agents Virtual Community, is a location on a communications network to which vendors, agents and the insurance carrier have access.

An embodiment of the invention features a system for providing access to insurance services by a plurality of independent insurance agents. The system includes a communications network that connects the plurality of independent insurance agents to a plurality of vendors; a database coupled to the communications network that contains client records to which separate access is provided to independent insurance agents having a proper identification code; an electronic common area in the communications network that connects the plurality of independent insurance agents and the plurality of vendors; and an insurance agent interface that allows each of the plurality of independent insurance agents having the proper identification code to select a plurality of vendors from the electronic common area and obtain access to the database.

Another embodiment of the invention features a system for coordinating customer services provided by a plurality of independent insurance agents by a provider. The system includes a high-speed electronic connection for coupling each of the plurality of independent insurance agents through a computing system to an electronic common area; a computer network in communication with the high-speed electronic connection that electronically links a plurality of vendors to the electronic common area; and means for enabling each of the independent insurance agents to contact each of the plurality of vendors through the computing system.

In yet another embodiment, the present invention features a system for providing access to insurance related services provided by a plurality of independent insurance agents. The system includes means for providing a communications network that connects the plurality of independent insurance agents to a plurality of vendors; a database coupled to the communications network that contains client records to which separate access is provided to independent insurance agents having proper identification; means for having as part of the communications network an electronic common area between the plurality of independent insurance agents and the plurality of vendors; and means for allowing the plurality of independent insurance agents to select a plurality of vendors from the electronic common area.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic diagram of a client-server communications network that electronically links a group of independent insurance agents to a group of vendors;

FIG. 2 is a schematic diagram of a client server communications network that electronically links a group of independent insurance agents, and a group of vendors to a virtual electronic community;

FIGS. 3A-3B provide a flowchart that shows an access method by which independent insurance agents and vendors access a computer network that implements a method of the present invention; and

FIG. 4 is a representation of a graphical user interface screen associated with the virtual electronic common area.

### DETAILED DESCRIPTION

Embodiments of the present invention generally relate to methods and systems for coordinating customer services between an insurance carrier, independent insurance agents, vendors, and insurance customers. In one embodiment, the present invention is directed to a method and system for coordinating customer services provided by a plurality of independent insurance agents by an insurance carrier.

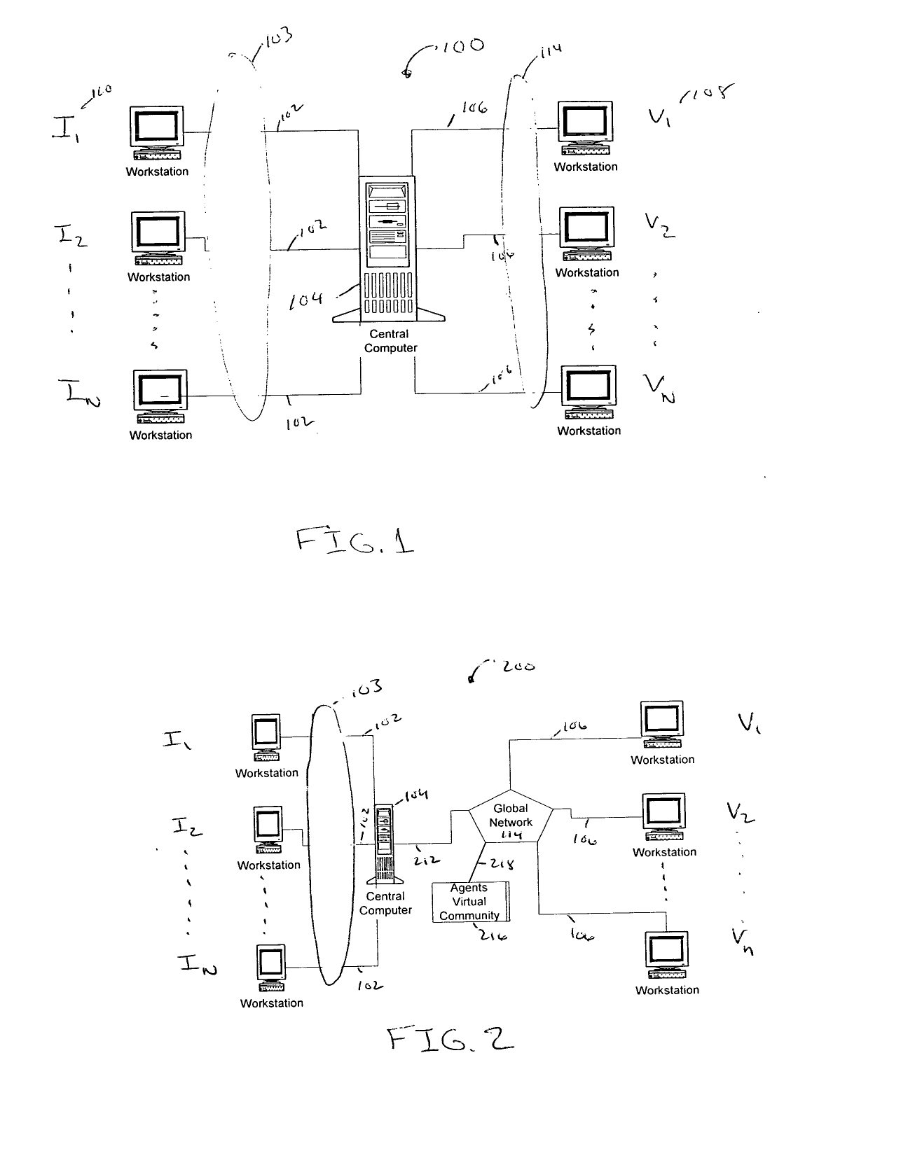

Referring to FIG. 1, the method includes the steps of coupling each of the plurality of independent insurance agents 110 to an electronic common area (not shown) through a computing network 100 via a high-speed electronic connection 102; coupling a plurality of vendors 108 to the electronic common area through a global communications network 114; and enabling each of the independent insurance agents 110 to contact each of the plurality of vendors 108 through the computing network 100. The method is described in further detail below, and implementation of a method of the invention utilizing a communications network 100 is also described hereinbelow.

Again referring to FIG. 1, a schematic diagram of a client-server communications network which links independent insurance agents, and vendors is shown. The communications network 100 shows a group of independent insurance agents 110 connected to a server or central computer 104 through high-speed communication lines 102. The communications network 100 also shows a group of vendors 108 electrically connected to the same central computer 104 through high-speed communication lines 106 that are also connected to a global communications network 114.

In a first embodiment of the present invention, the high-speed connection 102 between the group of independent insurance agents is electrically connected to a central computer 104. In one embodiment of the invention, the central computer 104 is an AS/400 mainframe computer provided by International Business Machines, Inc. (IBM). In another embodiment of the invention, the high-speed connection 102 includes a 56K-frame relay network where 56K represents a transmission rate of 56 kilobits per second.

In general, frame relays connect multiple local area networks (LANs) to a single high-speed wide area network (WAN) link using virtual circuits. A virtual circuit is a logical connection between several locations. For example, given independent agents I₁, I₂, . . . , I_{N}, a frame relay service provider, and a site location of an insurance carrier, the independent agents are each electrically connected to the insurance carrier's site through the frame relay service provider. However, although the agents and carrier are electrically connected, there are no point-to-point or one-to-one electrical contacts directly linking the agents 110 to the insurance carrier. As a result, the electrical connections are logical connections referred to as virtual circuits. Instead of utilizing direct electrical contacts, the agents are routed through a frame cloud 103, situated with the frame relay service provider that essentially compresses the various transmissions from the independent agents 110 to a single access point 104 located at the insurance carrier's site.

The frame cloud 103 includes a packet switching configuration that directs and transmits data signals based upon available bandwidth. The frame cloud 103 is made up of a series of communication lines that provide the necessary bandwidth to support the independent agents 110. In general, the frame cloud 103 provides a number of virtual circuits that connect stations attached to the same frame relay network and transfers data to a single access point. In one embodiment of the invention, the single access point includes the central computer 104, and the central computer 104 is connected by eight T-1 communication lines 102 extending from the frame cloud 103.

The frame relay communications system further consists of a network backbone made up of programmed switches that facilitate high-speed digital connections from one point to another. The switches are generally programmed to handle the flow control of data packets between a sender, a receiver and any intervening frame routers that provide an electrical connection between workstations in a local area network (LAN) and the wide area network. A frame relay communications system has been described in an article entitled “Frame Relay: Documentation” provided by Cisco Systems, Inc. A further description of a frame relay communications system has been described in an article entitled “Using Frame Relay to Integrate the Enterprise” by Robert C. Raciti. Both articles have been incorporated herein by reference.

Typically, a public frame relay supplier such as American Telephone and Telegraph, Inc. (AT&T) provides the frame relay service. In one embodiment of the invention, the frame relay service provides a 56 Kb/s data communications link between the independent agents 110 and the central computer 104.

In one aspect of the invention, the frame relay communication system provides a virtual data network service, which allows customers to simulate a dedicated high-speed data network. The frame relay communication system allows customers to define logical channels and establish permanent virtual circuits (PVCs) among multiple locations using statistically multiplexed network access lines and a shared high-speed telephone company packet switching network. In this aspect of the invention, the PVCs provide the customer with an electronic equivalent of a private line between two points.

The frame relay communication system allows customers to interconnect geographically dispersed local area networks and can support file transfer applications. The frame relay communications system supports intermittent, bursty data traffic via 56 Kbps and 1.544 Mbps transport facilities. In an alternative aspect of the invention, access through the frame relay communications ports may be provided via a digital data service (DDS) from the customer's location to a nearest frame relay service point.

In one embodiment of the invention, the digital data service is provided by BELL-ATLANTIC and may be a four wire leased line circuit that links a data resource location with full duplex, synchronous transmission of digital signals, with transmission speed choices of 2.4, 4.8, 9.6, 19.2, and 56 Kbps. The BELL-ATLANTIC DDS offers the flexibility of point-to-point, multi-point, and/or point-to-serving wire center configurations. In this configuration, the digital data service offers increased reliability, no conversion to analog is required, and information is transmitted end-to-end in a digital format. The BELL-ATLANTIC DDS may also be less expensive than dial up modem transmission, work at higher network speeds than dial up modem lines, and have a high reliability (as measured by a percent of error free seconds) and maximum availability (as measured by an amount of network time available for transmissions).

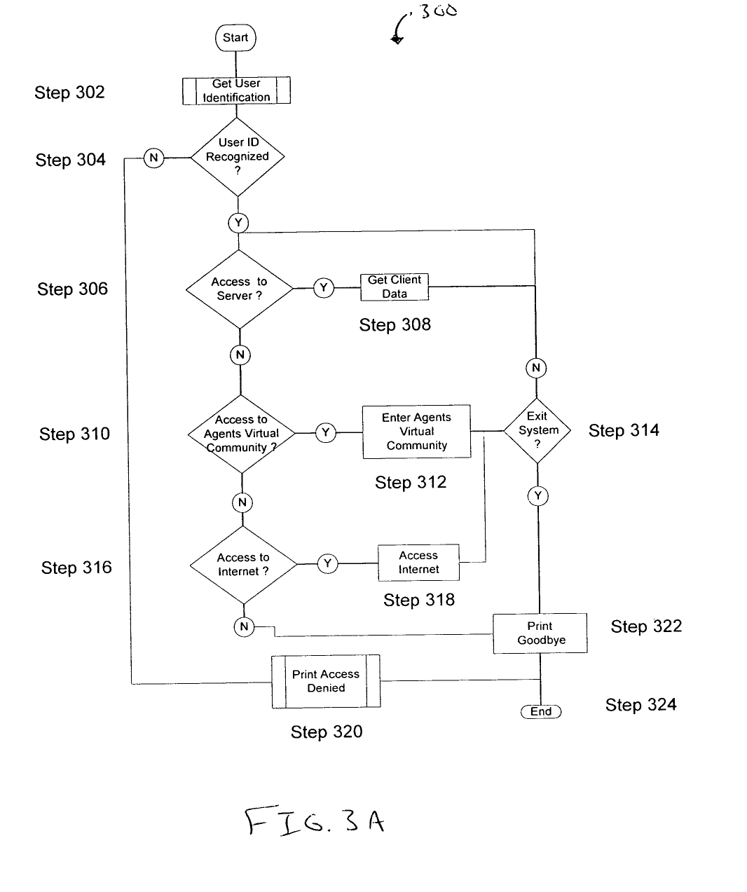

Referring to FIG. 2, in a further aspect of the invention, the group of vendors 108 is connected to a global communications network 114 via a standard T-1 communication line 106. The central computer 104 provides a direct connection to the global communications network 114 via a standard T-1 communications link 212. In this way, the group of independent insurance agents 110 is able to communicate with the group of vendors 108 through the central computer 104. In addition, the group of independent agents is also given access to the global communications network 114 via a communications link 212. In one embodiment of the invention, the communications link 212 is also a high-speed T-1 communications line.

As is well known in the art, a T-1 communication line is a digital carrier component used to transmit a DS-1 formatted digital signals at 1.544 Mb/s. Generally, utilizing a T-1 line presumes the use of two-pair of copper wires as the transmission medium. In addition, DS-1 represents a digital signal level one at which a 1.544 Mb/s digital signal comprising twenty four DS-0 signals, and a framing bit including 193 bits are transmitted at 8 Kb/s via a T-1 transmission line. The DS-0 represents a digital signal level zero in which the bandwidth of a digitized pulse code modulated voice signal is 64 kb/s for carrying voice or data.

Again, referring to FIG. 2, the group of independent insurance agents 110 are electrically connected to the central computer 104 via an electrical connection 102. The central computer 104 is shown electrically connected to a global communications network 114. In one embodiment of the present invention, the global communications network 114 is the INTERNET which may include the World Wide Web.

The global communications network 114 is electrically connected to the Agents Virtual Community™ 216 via a communications link 218. As described above, the group of vendors 108 are shown electrically connected to the global network 114 via a communications link 106. Note that in order to access the global communications network 114 and the Agents Virtual Community 216, the group of independent agents 110 are channeled through the central computer 104. Thus, access by the group of independent insurance agents 110 to the Agents Virtual Community 216 is limited by their access to the central computer 104. As shown in FIG. 2, access to the Agents Virtual Community 216 by the group of vendors 108 is not limited by their access to the central computer 104. However, in one embodiment of the invention, the Agents Virtual Community may be located on the central computer 104 thereby requiring the vendors to have limited access to the server 104.

In general, access to the Agents Virtual Community 216 is provided through a high-speed communications link 218. In one embodiment of the invention, the communications link 218 is a high-speed T-3 communications line. The T-3 communications link 218 provides an electrical connection between the global communications network 114 and the Agents Virtual Community 216. As a result, the group of vendors may access the Agents Virtual Community 216 to update their services.

In one embodiment of the invention, the T-3 communication line consists of 672 individual channels, each of which supports a 64 Kbps digital signal. Internet Service Providers (ISPs) generally utilize the T-3 communication lines for connecting to an Internet backbone and for the backbone itself. As is well known in the art, the T-3 communication lines, also referred to as DS-3 lines, are typically digital signal level three lines that operate at 44.736 Mb/s. The DS-3 lines include seven DS-2 or twenty-eight DS-1 signals that may also be multiplexed onto a fiber optical carrier.

In a second embodiment of the invention, the group of independent insurance agents 110, are not hardwired through a frame cloud 103 and electrically connected to a central computer 104 maintained by the insurance carrier, and the communications link 218 is not hardwired to the Agents Virtual Community 216. Instead, the independent agents 110 and the vendors 108 are connected to the Agents Virtual Community 216 through an INTERNET type communications network service provider. In this embodiment of the invention, the network service provider designates a secure region of the INTERNET network 114 through which direct communications between the group of independent insurance agents 110, the insurance carrier, and the group of vendors 108 may occur. In this embodiment of the invention, only a secure region of the global communications network 114 that implements digital network security schemes utilizing encryption techniques such as public-key cryptography, and private-key cryptography is required.

Embodiments of the present invention described above enable each member of a group of independent insurance agents to contact each member of a group of vendors over a computer network.

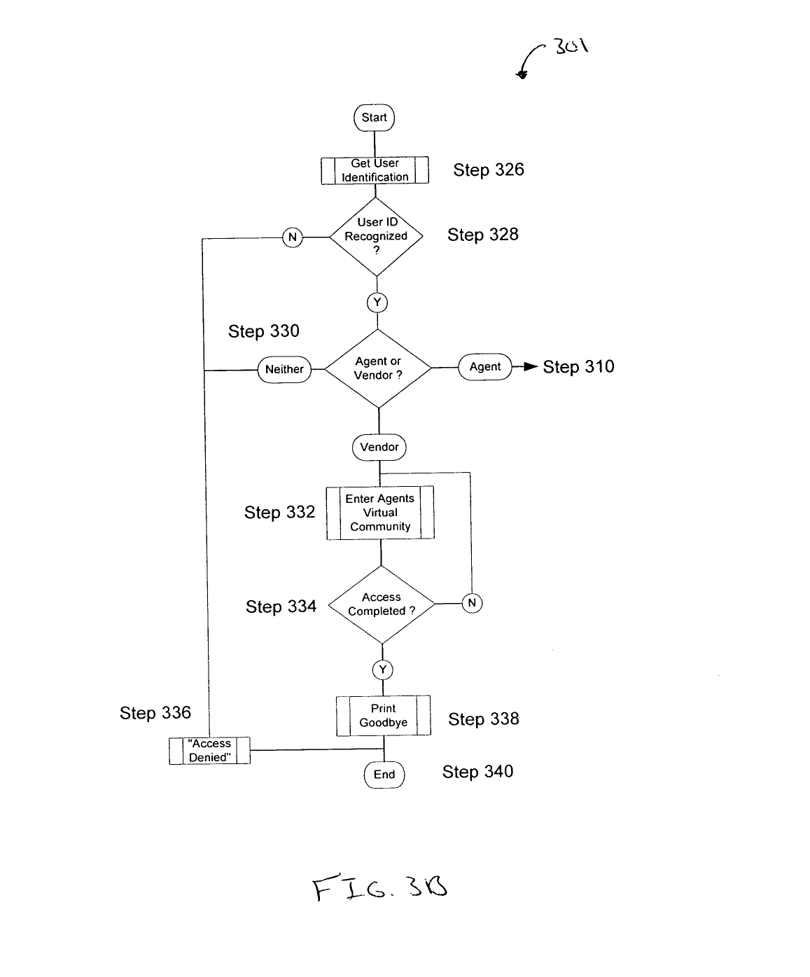

Referring to FIGS. 3A-3B, a flowchart 300 shows an access method by which the independent agents 110 access the computer network 200, and a flowchart 301 shows the method by which the vendors 108 access the computer network 200. In Step 302 of method 300, each member in the group of agents identifies himself or herself and is provided with a digital certificate. If the digital certificate or digital signature is authenticated (Step 304), the agent is allowed to continue, or else at Step 320 the agent receives an access denied prompt and is immediately removed from the system. A record of the attempted entry is made in the central computer 104.

In one embodiment of the invention, the digital certificate is an X.509 certificate. The X.509 certificate allows users to identify themselves remotely, and locally. The certificates may be installed on Windows® 95, Windows ® NT. The digital certificates primarily contain information about the holder's identity such as name, location, and/or a private identification number (PIN) obtained upon registering for access to the electronic common area 216. In one embodiment of the invention, the holder's identification is placed in an X.500 library that is used as a look-up table for users having proper access authority. The digital certificate is generally signed by a certificate authority. In one embodiment of the invention, the certificate authority can be the insurance carrier. However, the authorizing authority can be another entity solely responsible for network security.

In Step 304, if the computer system 200 authenticates the independent agent 110, then at Step 320, the computer system 200 determines whether access to a database of client files located on the central computer 104 is requested. If client data is requested, then the independent agent 110 is allowed access to the client data at Step 312. In one embodiment of the invention, the database of client data is stored on an AS/400 mainframe computer provided by International Business Machines, Inc. (IBM).

At Step 310, the independent agent 110 is provided access to the electronic common area 216. If access to the electronic community 216 is desired, then at Step 312 the independent agent 110 enters the Agents Virtual Community 216 and is able to access various vendors' sites. The independent agent 110 is also able to electronically connect to various industry links, send electronic mail (email) to vendors or other agents. In addition, the agent may be provided access to a suite of software products directed to insurance related services. In one embodiment of the invention, the suite of software products is stored on the server 104. Also, a gateway to the global communications network 114 is provided in the electronic common area 216.

At Step 316, the independent agent 110 is provided with an option to directly connect to the global communications network 216 at Step 318 without first going through the Agents Virtual Community 216. When the agent completes a session, the session is terminated through Steps 314, 322 and 324.

In one embodiment of the invention and referring to FIG. 3B, a flowchart 301 shows an access method by which the vendors 108 access the computer network 200. In Step 328 of method 301, the computer system 200 determines whether the digital signature obtained from Step 326 is authentic, and whether the signature belongs to an independent agent 110, or a vendor 108. If the signature is not recognized, then at Step 336 access is denied and the user is immediately removed from the system, and a record of the attempted entry is made. If the signature belongs to an agent 110, then the agent is redirected to Step 310 as described above. If the user is an authenticated vendor 108, then the vendor is permitted to enter the Agents Virtual Community at Step 332.

In this embodiment of the invention, the vendor 108 at step 330 only has access to the electronic common area 216 in Step 332. Once the vendor 108 enters the electronic common area 216, the vendor is able to place information regarding, location, services, and updated pricing information.

Although not shown in FIG. 3B, the vendor may be granted limited access to the central computer 104. The vendor may also be given the same path of entry to the central computer 104 as the independent agent 110 as shown in FIG. 3A. In that aspect of the invention, the vendors authenticated digital certificate from Step 328 might allow limited access to a database of client information located on the central computer 104. The vendor 108 may be granted access to the central computer 104 in order to retrieve information about a particular insurance claim file. When the vendor 108 completes updating the Agents Virtual Community 216, or reviewing the various features in the virtual community, the vendor 108 exits the system 200 through Steps 334, 338, and 340.

In another aspect of the invention, the vendor 108 while in the Agents Virtual Community can create a portal from the electronic common area 216 to another location on the global communications network 114 sponsored by the vendor 108.

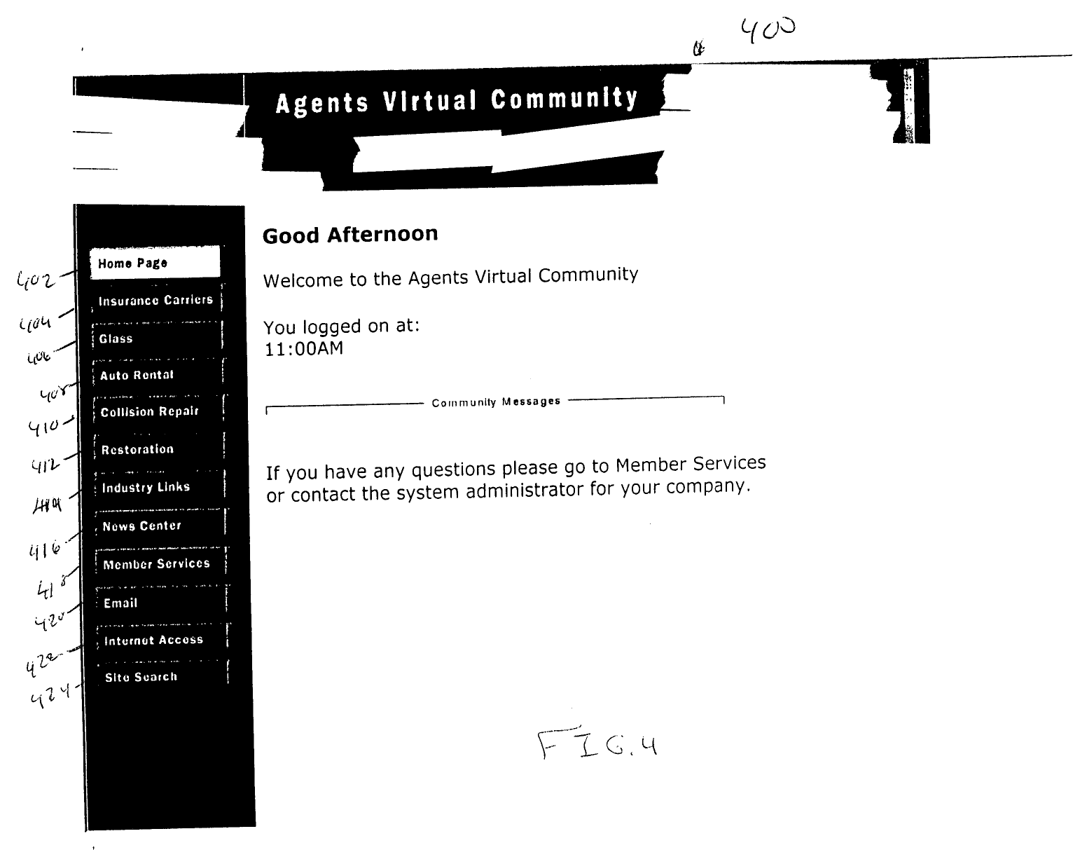

In one embodiment of the invention the electronic common area 216 is the Agents Virtual Community mentioned above. In one embodiment of the invention, a graphical user interface (GUI) screen represents the electronic common area 216. In one embodiment of the invention, each GUI screen provides automobile insurance related services and information to the user. FIG. 4 is a representation of a graphical user interface screen 400 associated with the electronic common area 216.

In one embodiment of the invention, the GUI screen 400 has twelve icons representing twelve different locations accessible within the global communications network 114, and accessible in the electronic common area 216. The GUI screens are generally operable with any available network browser provided by Netscape® or Microsoft ®. In one embodiment of the invention, the GUI screens are created using hypertext markup language (HTML). Each screen, represented by a separate icon, will now be described.

A home page icon 402 provides access to a welcoming page that identifies the user. The page also emulates a messaging board by generally providing information to the other system users. In one embodiment of the invention, when a user enters the electronic common area 216, the insurance carrier may provide a border around the web page that identifies itself as a sponsor of the web site.

An insurance carrier icon 404 provides a direct link to a web page that furnishes the user with an electronic gateway to the insurance carrier's web site.

A glass icon 406 provides an electronic link to a web page where automobile glass vendors and windshield repair vendors are able to offer their advertisement of services to the independent agents for a predetermined fee paid to the insurance carrier sponsoring the web site.

An auto rental icon 408 provides an electronic link to a web page that identifies national and local car rental agencies, associated rental information, services provided, price listings, and on-line automobile reservation services. The car rental agencies are able to place their logos or advertisements on the electronic virtual community web site for a predetermined user's fee paid to the insurance carrier.

A collision repair icon 410 provides an electronic link to a web page that identifies registered auto body repair shops and their locations. The auto body repair advertisers would also pay a fee to the insurance carrier.

A restoration icon 412 provides an electronic link to a web page that allows an authenticated agent 110 or vendor 108 access to the central computer 104 in order to update client database files.

An industry links icon 414 provides an electronic link to web page having communication links to various web sites within the global communications network 216 that provide information about the automobile insurance industry that might effect the group of vendors 108 and the independent agents 110. In one embodiment of the invention, the industry links include federal and state governmental sites, and general business and economic sites.

A news center icon 416 provides an electronic link to a web page having communication links to various web sites within the global communications network 216 that provide automobile insurance industry news.

A member services icon 418 provides an electronic link to a web page having communication links to the insurance carrier. In this location, the agent 110 is able to obtain various forms relevant to the industry, and sanctioned by the insurance carrier. In addition, the agent 110 is able to access information from other agents via an informational question and answer message board, and by sending/receiving electronic mail. The agent may also communicate with the insurance carrier regarding services being provided.

An electronic mail icon 420 provides access to a messaging system. In one embodiment of the invention, the messaging system utilizes standard simple mail transfer protocol (SMTP) which is a method for transmitting electronic mail to and from the INTERNET. In another embodiment, the messaging system may utilize an internet message access protocol (IMAP) mail service that enables an authorized local user to access electronic mail messages from a stand alone computer, workstation or laptop computer without transferring files between an agent 110, a vendor 108, and the server 104.

An INTERNET access icon 422 provides access to a portal that directly links the agent 110 with the global communications network 114. In one embodiment of the invention, the global communications network 114 is the INTERNET. In one embodiment of the invention, when the agent enters the INTERNET, the border around the web page identifying the insurance carrier is removed signifying that the agent 110 is no longer within the agents virtual electronic community 216.

A site search icon 424 allows the agent 110 to search the virtual electronic community web site and provides an electronic link for searching the INTERNET.

Embodiments of the present invention overcome problems associated with the prior art in providing a single virtual location in which independent insurance agents, insurance related vendors and an insurance carrier are able to dispense insurance related services, and a single location in which customers are able to resolve their insurance related needs. Having thus described at least one illustrative embodiment of the invention, various modifications, alterations, and improvements are intended to be within the scope and spirit of the invention.

Accordingly, the foregoing description is by way of example only and not intended as limiting. The invention's limit is defined only in the following claims and the equivalents thereto.

What is claimed is:

1. A method for coordinating customer services provided by a plurality of independent insurance agents in the automobile insurance industry, the services being offered through an insurance carrier, the method comprising the steps of:
coupling each of the plurality of independent insurance agents through a computing device having a display interface, to an electronic common area hosted by at least one insurance carrier, through a computing network via a high-speed electronic connection;
providing each of the plurality of independent insurance agents access to a database of client records, whereby accessing the database requires an authenticated identification code;
coupling a plurality of automobile service vendors to the electronic common area through a global communications network, the automobile service vendors including at least one of auto repair shops, window and window replacement centers, rental car providers, and providers of replacement automotive parts;
enabling the plurality of automobile service vendors to enter vendor information and to update vendor information in the electronic common area, the vendor information including at least one of location, services offered, and service pricing information;
providing a user interface to the display interface of the computing device, the user interface displaying a plurality of icons representing the plurality of automobile service vendors; and
enabling each of the independent insurance agents to contact each of the plurality of automobile service vendors through the computing network by selecting one of the plurality of automobile service vendor icons on the display interface.

2. The method of claim 1 further comprising the step of:
providing insurance related software applications to each of the plurality of independent insurance agents over the computing network.

3. The method of claim 1 further comprising the step of:
using digital certificates to provide security over the computing network.

4. The method of claim 1 wherein the step of coupling each of the plurality of independent insurance agents to the electronic common area through the computing network via the high-speed electronic connection comprises coupling through a dedicated communication system using frame routers.

5. The method of claim 1 wherein the step of coupling each of the plurality of independent insurance agents to a computing system includes the step of coupling the agents through a global communications network connection.

6. A method of providing access to insurance related services offered through an insurance carrier by a plurality of independent insurance agents, the method comprising the steps of:
providing a communications network that connects the plurality of independent insurance agents to a plurality of automobile service vendors through a computing device having a display interface, the automobile service vendors including at least one of auto repair shops, window and window replacement centers, rental car providers, and providers of replacement automotive parts;
providing as part of the communications network an electronic common area, hosted by at least one insurance carrier, between the plurality of independent insurance agents and the plurality of automobile service vendors;
providing a user interface to the display interface of the computing device, the user interface displaying a plurality of icons that represent the plurality of automobile service vendors;
providing as part of the communications network a database having client records and requiring an identification code with which the database can be accessed; and
allowing the plurality of independent insurance agents to select a plurality of automobile service vendors from the electronic common area by clicking on the icons that represent the insurance related vendor services and the plurality of automobile service vendors on the display interface.

7. The method of claim 6 wherein the step of providing a communications network further comprises the step of:
providing a high-speed electronic connection between the plurality of independent insurance agents and the plurality of automobile service vendors whereby the high-speed electronic connection comprises frame relays and a global communications network connection.

8. The method of claim 6 wherein the step of providing as part of the communications network an electronic common area further comprises the step of:
providing network security using digital certificates to identify the plurality of independent insurance agents, and the plurality of automobile service vendors before allowing access to the electronic common area.

9. A system for providing access to insurance related services by a plurality of independent insurance agents, the system being offered by an insurance carrier and comprising:
a communications network that connects the plurality of independent insurance agents to a plurality of automobile service vendors through a computing device having a display interface, the automobile service vendors including at least one of auto repair shops, window and window replacement centers, rental car providers, and providers of replacement automotive parts;
a database coupled to the communications network that contains client records to which separate access is provided to independent insurance agents having a proper identification code;
an electronic common area in the communications network and hosted by at least one insurance carrier that connects the plurality of independent insurance agents and the plurality of automobile service vendors, the electronic common area including a user interface to the display interface of the computing device, the user interface displaying a plurality of automobile service vendor icons representing vendor information for the plurality of automobile service vendors, the vendor information including at least one of location, services offered, and service pricing information; and
an insurance agent interface that allows each of the plurality of independent insurance agents having the proper identification code to select a plurality of automobile service vendors from the electronic common area and obtain access to the database by selecting one of the plurality of automobile service vendor icons on the display interface.

10. A system for coordinating automobile insurance industry customer services provided to a plurality of independent insurance agents by an insurance carrier, the system comprising:
a high-speed electronic connection for coupling each of the plurality of independent insurance agents through a computing system having a display interface to an electronic common area hosted by at least one insurance carrier;
a computer network in communication with the high-speed electronic connection that electronically links a plurality of automobile service vendors to the electronic common area, the plurality of automobile service vendors including at least one of auto repair shops, window and window replacement centers, rental car providers, and providers of replacement automotive parts; and
means for enabling each of the independent insurance agents to contact each of the plurality of automobile service vendors through the computing system, the means for enabling including selecting at least one of a plurality of automobile service vendor icons displayed on the display interface.

11. A system for providing access to insurance related services provided by an insurance carrier to a plurality of independent insurance agents, the system comprising:
means for connecting the plurality of independent insurance agents to a plurality of automobile service vendors through a computing device having a display interface, the plurality of automobile service vendors including at least one of auto repair shops, window and window replacement centers, rental car providers, and providers of replacement automotive parts;
a database coupled to the communications network that contains client records to which separate access is provided to independent insurance agents having proper and authenticated identification,
wherein the means for connecting includes means for providing an electronic common area between the plurality of independent insurance agents and the plurality of automobile service vendors, the electronic common area including a user interface to the display interface of the computing device for displaying a plurality of automobile service vendor icons; and
means for allowing the plurality of independent insurance agents to select a plurality of automobile service vendors from the electronic common area by selecting one of the plurality of automobile service vendor icons on the display interface, wherein selecting an automobile service vendor icon provides vendor information including at least one of location, services offered, and service pricing information.
